(19) United States
(12) Patent Application Publication
(10) Pub. No.: US 2011/0121581 A1
(43) Pub. Date: May 26, 2011

(54) Nuvolt power system "NPS"

(75) Inventor: James Edward McLean, JR., Charlotte, NC (US)

(73) Assignee: McLean Technology

(21) Appl. No.: 12/657,174

(22) Filed: Jan. 15, 2010

Related U.S. Application Data
(60) Provisional application No. 61/281,755, filed on Nov. 23, 2009.

(51) Int. Cl. H02K 7/18; H02P 9/04; H02N 11/00

(52) U.S. Cl. 290/1 R; 290/7; 415/916

(57) ABSTRACT

Unlike current electric generators; the Nuvolt Power System “NPS” is an electric generator that, once started, will produce electrical power continuously, without the aid or use of external energy sources such as: mechanical, fuel, waves, wind, solar or electrical energy.

### CROSS-REFERENCE TO RELATED APPLICATIONS

This application is claiming the benefits of the provisional application of the Nuvolt Power System “NPS, received/filed with the “USPTO” on Nov. 23, 2009, identified by the application No. 61/281,755

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1) “NPS” is in the field of electric generators.

2) In todays electric generators, some external mechanical force or device is connected to the armature shaft, or rotating part of the generator. This external force-device turns the shaft of the armature or rotating part of the generator, which cuts through the magnetic flux lines of a magnetic field, thus, producing power to an attached load.

3) The specific problems involved with the prior state of electric “generator technology” are: they require some form of external energy, such as: mechanical energy, fuel, wind or wave energy to effectively operate or produce the desired results (electrical power); also, some electric generators require the use of components, such as: commutators, brushes, sliprings, or excitation current; and contains one of the following configurations: “a permanent magnet with an electro-magnet-coil”, or “two electromagnets-coils”, in order to produce electrical power. Finally, they lack the ability to self store electric power.

### BRIEF SUMMARY OF THE INVENTION

“NPS” is an electrical energy device (machine) that produces power without the aid of external mechanical force, fuel, wind, or wave energy. Nor does it utilize commutators, brushes, sliprings to change the poles of its magnetic fields. “NPS” has the ability to produce alternating current “AC”, and direct current “DC”, and can store this “DC” power. Unlike the current electric generator, “NPS” does not use any of the methods (electromagnet and a permanent magnet, or two electromagnets) to create electric power; nor does it incorporate: commutators, brushes, sliprings or the need of excitation current. The “NPS” achieves it's mechanical force by: two or more permanent magnets of the same poles (special size and a certain shape), stationary and non-stationary. These magnets are positioned so as to assert a force on the non-stationary magnet(s); thus, causing movement or rotation. The object of the “NPS” is to provide an alternative energy-power source for consumers and businesses.

### BRIEF DESCRIPTION OF THE SEVERAL VIEWS OF THE DRAWINGS

FIG. 1: Shows the left front view of the “NPS” (machine).

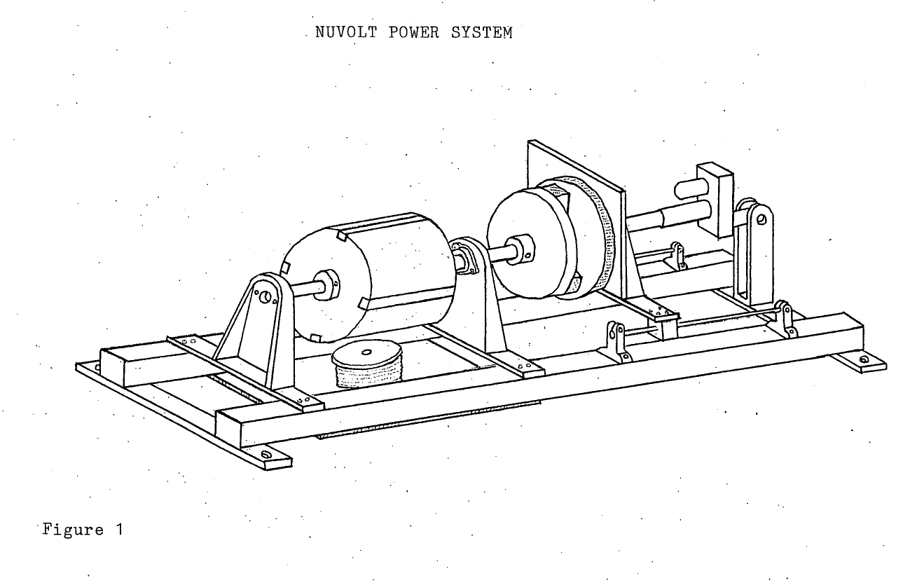

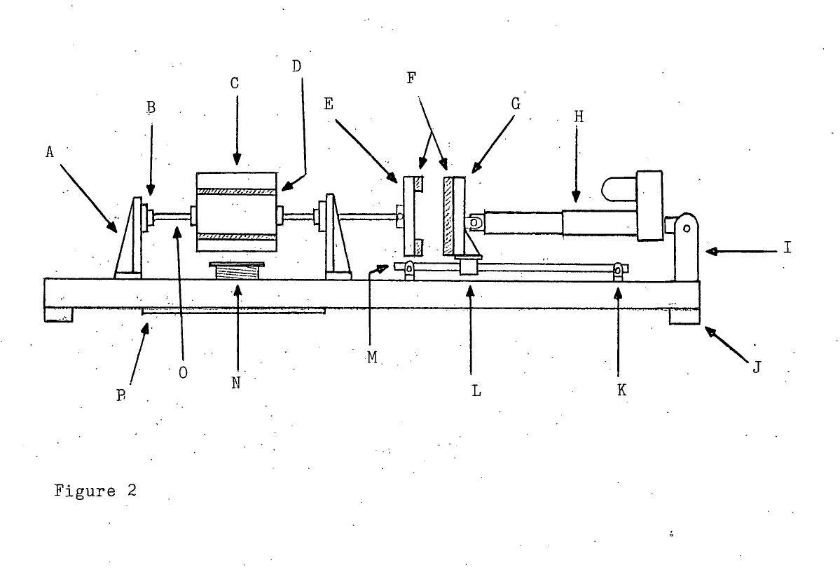

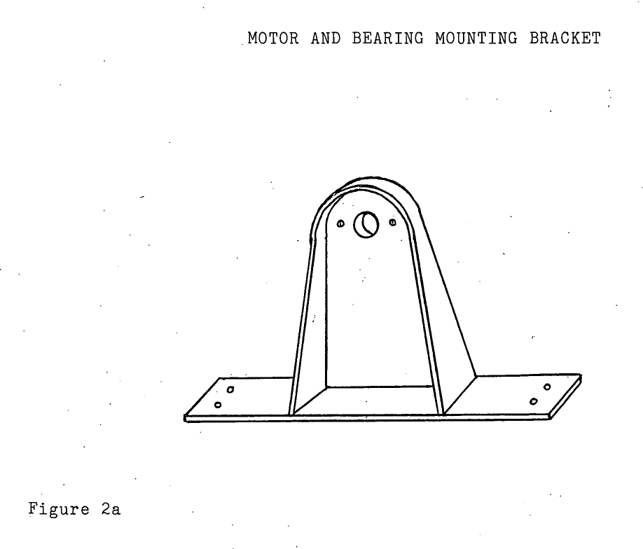

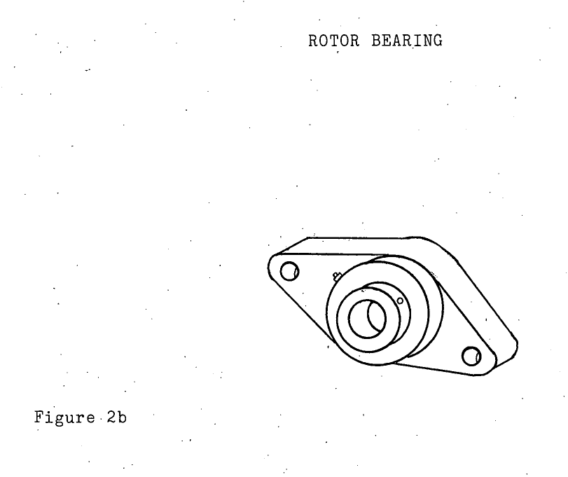

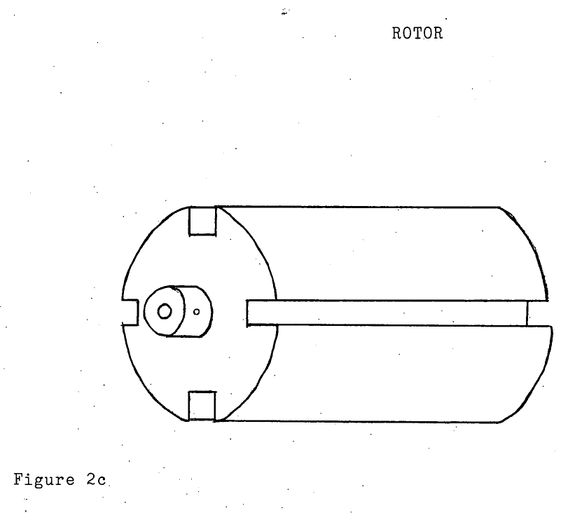

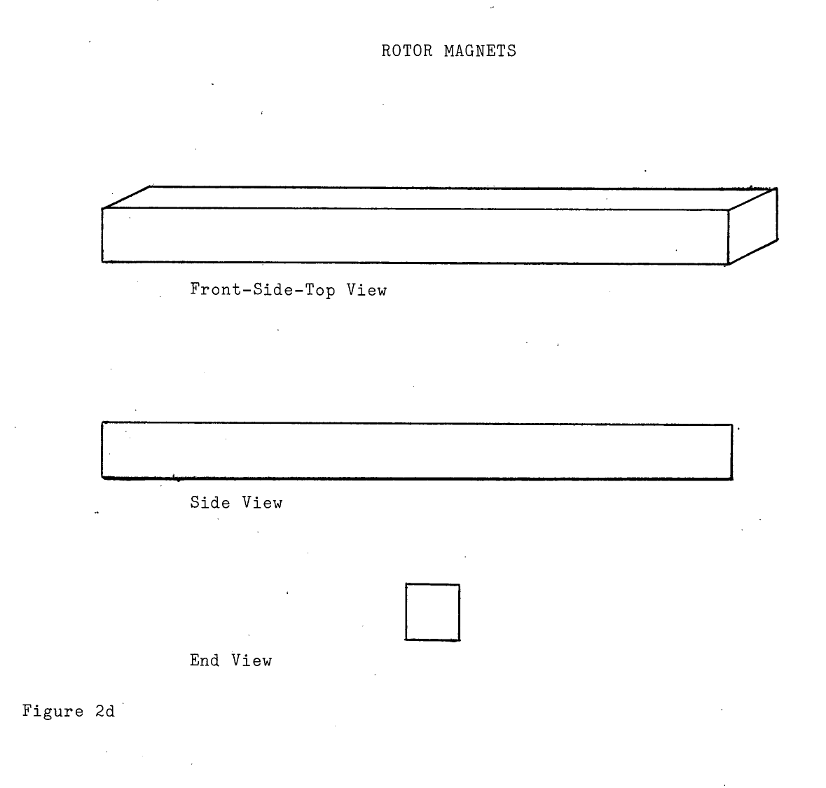

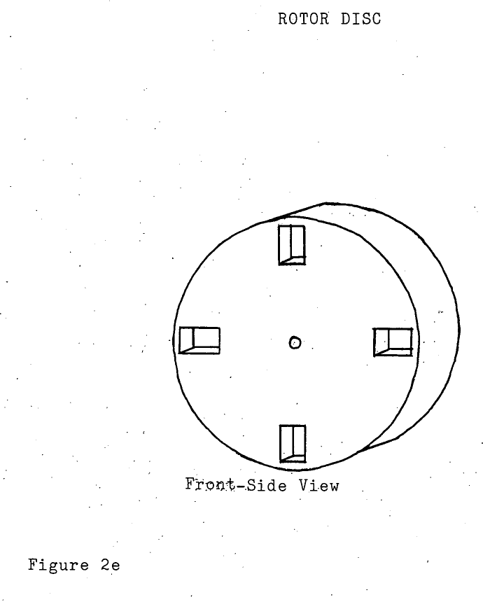

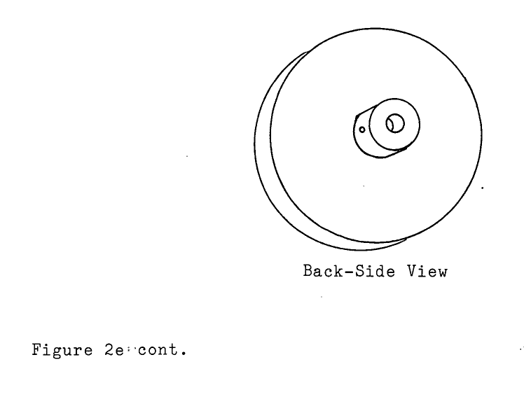

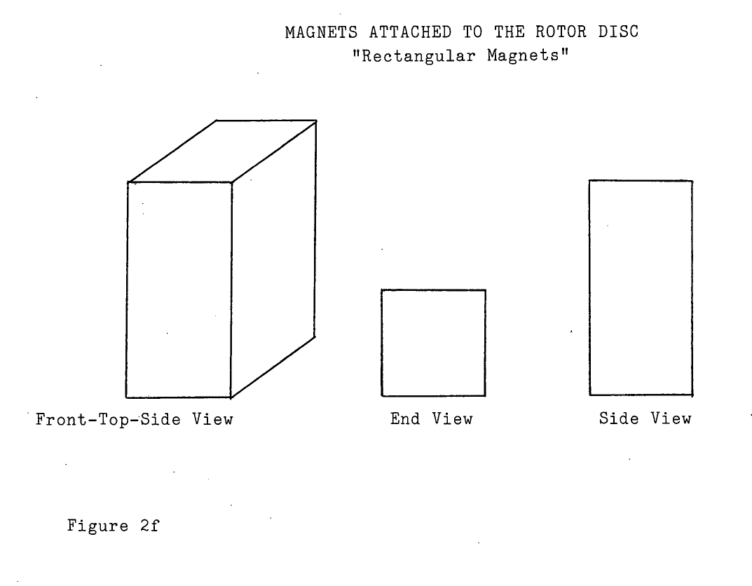

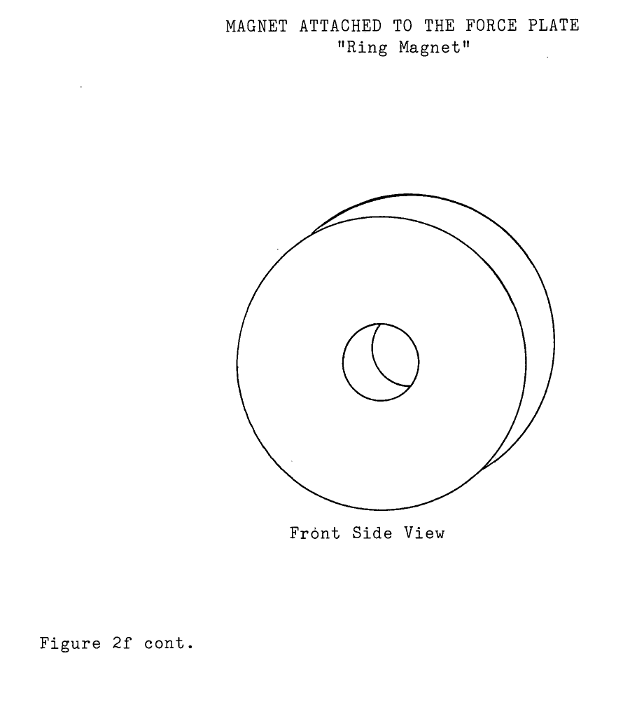

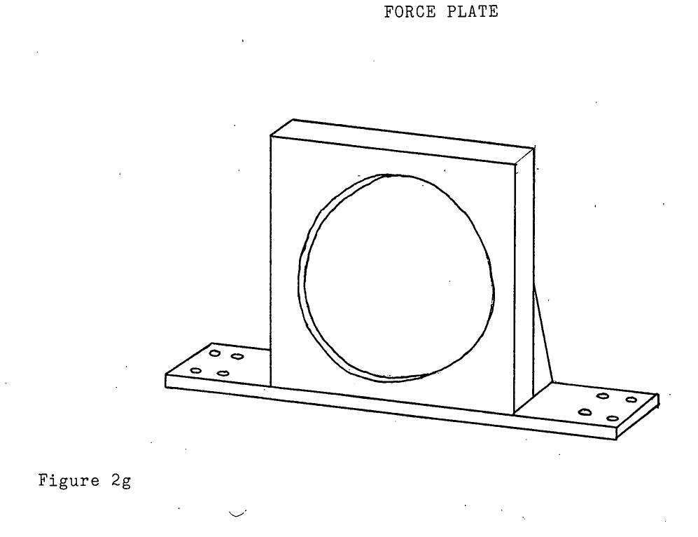

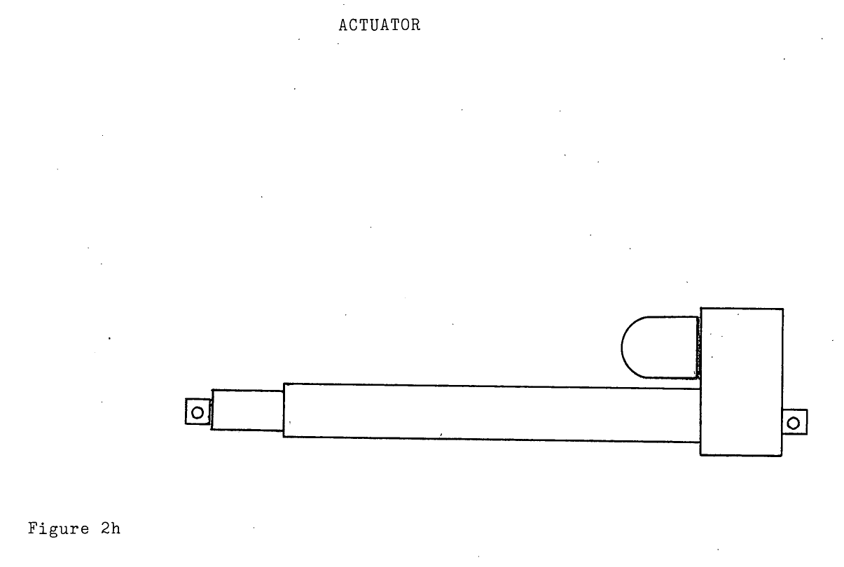

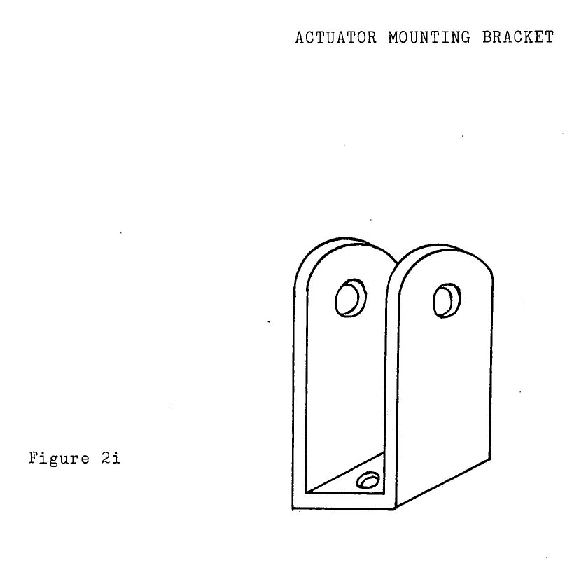

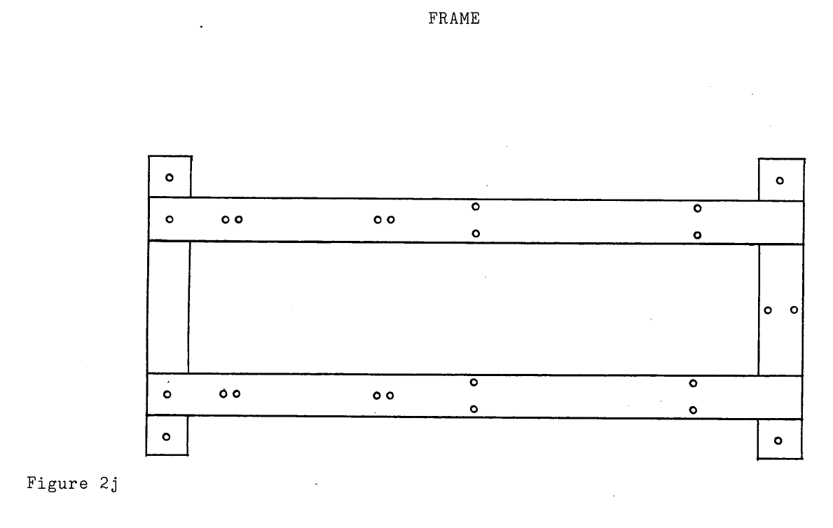

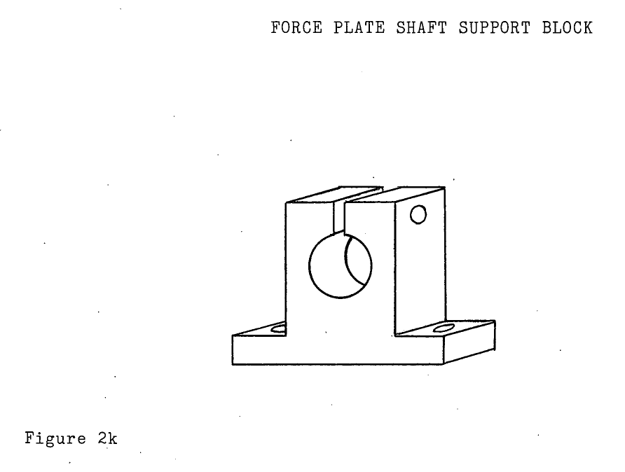

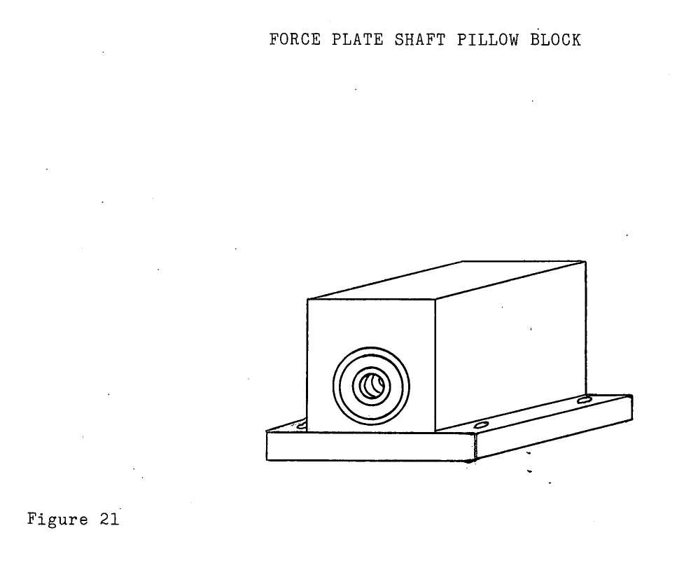

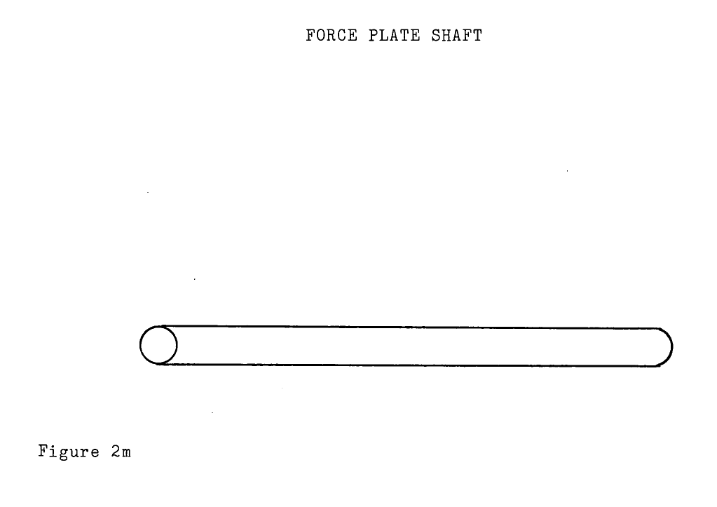

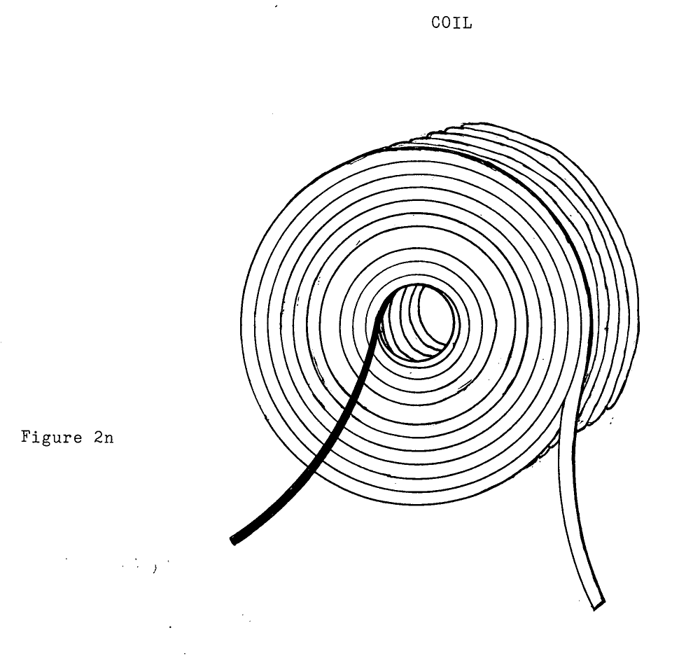

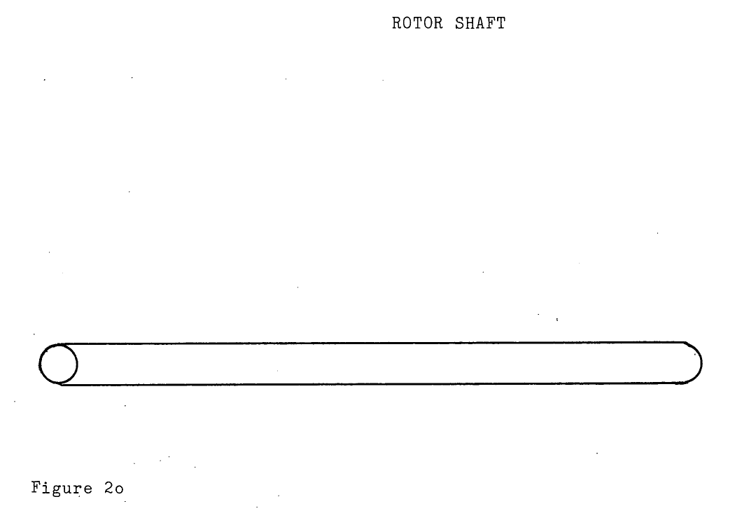

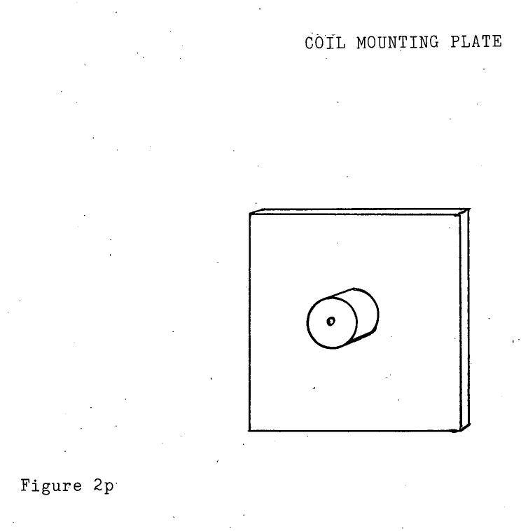

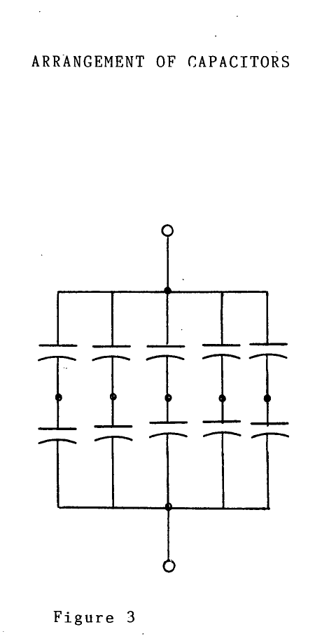

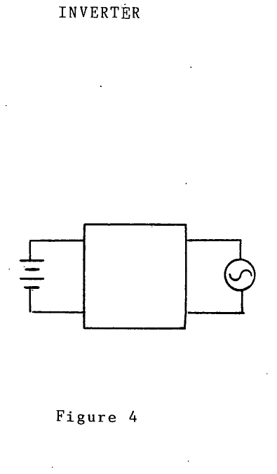

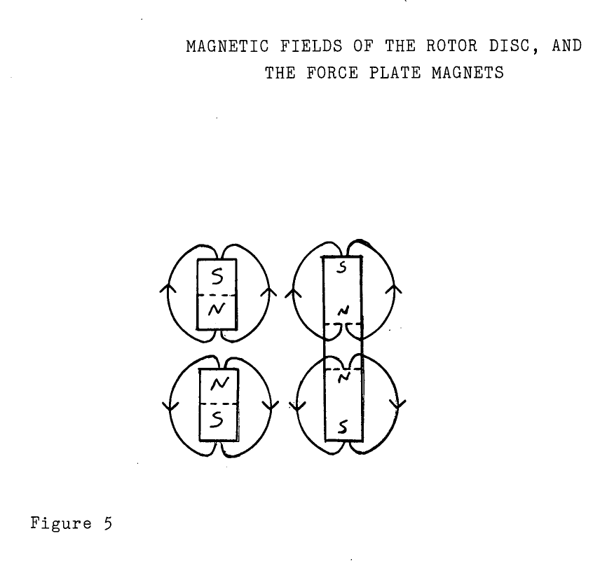

FIG. 2: Shows the left-side view of the “NPS” (machine).
Line “A” shows the rotor and bearing mounting bracket;

FIG. 2a is the expanded view.
Line “B” shows the rotor bearing;

FIG. 2b shows the expanded view.
Line “C” shows the rotor;

FIG. 2c shows the expanded view.
Line “D” shows the rotor magnets;

FIG. 2d shows the expanded view.
Line “E” shows the rotordisc;

FIG. 2e shows the expanded view.
Line “F” shows the magnets attached to the rotor disc and the force plate;

FIG. 2f shows the expanded view.
Line “G” show the force plate;

FIG. 2g shows the expanded view.
Line “H” shows the actuator;

FIG. 2h shows the expanded view.
Line “I” shows the actuator mounting bracket;

FIG. 2i shows the expanded view.
Line “J” shows the frame;

FIG. 2j shows the expanded view.
Line “K” shows the force plate shaft support block;

FIG. 2k shows the expanded view.
Line “L” shows the force plate shaft pillow block;

FIG. 2l shows the expanded view.
Line “M” shows the force plate shaft;

FIG. 2m shows the expanded view.
Line “N” shows coil,

FIG. 2n shows the expanded view.
Line “O” shows the rotor shaft;

FIG. 2o shows the expanded view.
Line “P” shows the coil mounting plate;

FIG. 2p shows the expanded views.

FIG. 3: Shows the capacitor arrangement for energy storage.

FIG. 4: Shows the inverter, which changes “Direct Current” into “Alternating Current”.

FIG. 5: Shows the magnetic fields of the rotor disc, and the force plate magnets.

### DESCRIPTION OF THE INVENTION

Nuvolt Power System is: an electrical energy device (machine); once started, will produce electrical power continuously; and store this power for a period of time after the device is stopped. The electrical power that is produced is: Alternating Current (AC) and Direct Current (DC); the electric power stored is: DC.

Power is created by a special arranged magnetic field attached to a force plate that is moved to a position near to another magnetic field of the same pole, that is attached to a rotor disk; these two magnetic fields have “flux lines” that are propagating in the same directions so as to combine and assert a force on the rotor disk; the rotor disk in turn starts to rotate an attached magnetic rotor that has magnets arranged to produce a magnetic field (flux lines) that induces a current into a coil that is located nearby. This current is “DC”, and is routed by copper conductors to a special arrangement of capacitors for storage and “DC” output. Alternating Current is accomplished by an Inverter, or a rotor that is fixed with a pair of opposite magnetic fields. The force plate is attached to an actuator, which is used to start and stop the machine. The actuator starts the machine by pushing the force plate towards the rotor disk; the opposite is true to stop the machine. Also, the actuator, in the case of an “AC” rotor, is used to control and adjust frequency. This is accomplished by moving the force plate closer to the rotor disk, the increase force of the repelling magnetic fields will cause the rotor disk to spin faster, thus, turning the rotor faster, which results in an increased frequency, the opposite is true to decrease the frequency.

1. My claim is: A device that incorporates both stationary and non-stationary permanent magnets (including a coil with a metallic core that retains residual magnetism), with magnetic fields arranged so as to repel each other, when moved or placed close together by an actuator, or some other means, so as to assert a force on the non-stationary permanent magnet(s), which causes it to rotate or move, in any manner, so as to induce, or cause the induction of a voltage or current in a coil.

2. My claim is: A device that generates electrical power by means outlined by claim “1” above, and stores this electrical power by means of capacitor(s) or cell(s).

3. My claim is: A device as outlined by claim “1” above, and incorporates an electrical/electronic control circuit that senses and controls the frequency output (frequency regulation).

4. My claim is: A device as outlined by claim “1” above, and incorporates an electrical/electronic control circuit that senses and controls the voltage output (voltage regulation).

5. My claim is: A device as outlined by claim “1” above, and incorporates an electrical/electronic control circuit that senses and controls: current output, over current, ground fault current, surge, or any combination of these functions, (current regulation).

6. My claim is: A device as outlined by claim “1” above, and incorporates an electrical/electronic circuit that senses and controls the temperature (thermal overload protection) of the device.

7. My claim is: A device as outlined by claim “1” above, and incorporates an electrical/electronic control circuit that senses and controls the charging of capacitors and/or cells.

8. My claim is: A device as outlined by claim “1” above, and incorporates permanent magnet rings(s) or disk(s).

9. My claim is: A device as outlined by claim “1” above, and incorporates an inverter.

10. My claim is: A device as outlined by claim “1” above, and incorporates a “force plate” attached to an actuator, or moving device.

11. My claim is: A device as outlined by claim “1” above, and incorporates a rotor disc attached to the shaft of a rotor, or armature.

12. My claim is: A device as outlined by claim “1” and “8” above, with the magnet ring(s) magnetized so as to have one pole being the outer diameter and the other pole being the inter diameter, so as to produce magnetic lines of flux that are symmetrically arranged around the face of the ring(s).
